(19) United States
(12) Patent Application Publication
(10) Pub. No.: US 2020/0172670 A1
(43) Pub. Date: Jun. 4, 2020

(54) PARTS MADE FROM POLYETHERKETONEKETONE HAVING IMPROVED DIMENSIONAL STABILITY

(71) Applicant: Arkema France, Colombes (FR)

(72) Inventors: Benoît BRULE, Beaumont-le-Roger (FR); Nadine DECRAEMER, Beaumontel (FR); Ilias ILIOPOULOS, Paris (FR)

(73) Assignee: Arkema France, Colombes (FR)

(21) Appl. No.: 16/640,178

(22) PCT Filed: Sep. 10, 2018
(86) PCT No.: PCT/FR2018/052204

§ 371 Date: Feb. 19, 2020

(30) Foreign Application Priority Data
Sep. 8, 2017 (FR) 1758296

(51) Int. Cl. C08G 65/40; B29C 71/00; B29C 71/02

(52) U.S. Cl. CPC C08G 65/4012; B29K 2071/00; B29C 71/02; B29C 71/0063

(57) ABSTRACT

A part including polyetherketoneketone, in which the polyetherketoneketone is at least partially crystalline and in which at least 50% by weight of the crystalline polyetherketoneketone is of form 1. Also a process for the manufacture of such a part, the process including the provision of polyetherketoneketone; the shaping of the polyetherketoneketone and the at least partial crystallization of the polyetherketoneketone in the form 1.

### FIELD OF THE INVENTION

The present invention relates to parts made of polyetherketoneketone exhibiting an improved high-temperature dimensional stability, and to their process of manufacture.

### TECHNICAL BACKGROUND

Polyetherketoneketone (PEKK) is a polymer which exhibits a high melting point, excellent mechanical properties and a very good chemical resistance.

For this reason, PEKK is a particularly advantageous polymer for demanding technical fields, such as, for example, the aerospace industry.

PEKK can comprise different units, derived from terephthalic acid and from isophthalic acid. Some properties of PEKK, such as its melting point or its kinetics of crystallization, depend on the proportion of these respective units.

The paper Structure, crystallisation and morphology of poly(aryl ether ketone ketone), by Gardner et al., in Polymer, 33, 2483-2495 (1992), describes the existence of two crystalline forms, called form 1 and form 2, for PEKK.

In some applications, parts exhibiting a good dimensional stability, including at high temperature, are sought. More specifically, the parts, exposed to a high temperature, must not undergo significant deformations of the warping or bending or shrinking or elongating type.

There thus exists a need to provide parts made of thermoplastic material exhibiting a high dimensional stability, including at high temperature.

### SUMMARY OF THE INVENTION

The invention relates firstly to a part comprising polyetherketoneketone, in which the polyetherketoneketone is at least partially crystalline and in which at least 50% by weight of the crystalline polyetherketoneketone is of form 1.

According to some embodiments, at least 80% by weight, preferably at least 90% by weight and more particularly preferably essentially all of the crystalline polyetherketoneketone is of form 1.

According to some embodiments, the polyetherketoneketone comprises at least 10% by weight, preferably at least 15% by weight, of crystalline polyetherketoneketone.

According to some embodiments, the polyetherketoneketone comprises terephthalic units and optionally isophthalic units, the proportion by weight of the terephthalic units, with respect to the sum of the terephthalic units and of the isophthalic units, being from 35% to 100%, preferably from 55% to 85%.

According to some embodiments, the polyetherketoneketone represents at least 30% by weight, preferably at least 50% by weight, more preferably at least 70% by weight and ideally at least 80% by weight of the part.

According to some embodiments, the part also comprises one or more additional elements chosen from fillers, including preferably fibers, one or more other polyaryletherketones, additives and the combinations of these.

According to some embodiments, the part is a part of an air or space locomotion craft, or a part of a drilling installation, or a part intended to be positioned in contact with or close to a vehicle engine or a reactor, or a part intended to be subjected to friction.

The invention also relates to the use of the above part in an appliance, craft or system, the part being subjected to a continuous operating temperature of greater than or equal to 200° C., or greater than or equal to 230° C., or greater than or equal to 260° C., or greater than or equal to 280° C.

According to some embodiments, the use is made in an appliance, craft or system, the part being subjected to a maximum temperature of greater than or equal to 200° C., or greater than or equal to 250° C., or greater than or equal to 300° C., or greater than or equal to 320° C.

The invention also relates to a process for the manufacture of a part as described above, comprising:
the provision of polyetherketoneketone;
the shaping of the polyetherketoneketone and the at least partial crystallization of the polyetherketoneketone in the form 1.

According to some embodiments, the shaping is carried out by injection molding, by injection/compression molding or by extrusion.

According to some embodiments, the process comprises a stage of heat treatment after the shaping stage.

The present invention makes it possible to meet the need expressed in the state of the art. It more particularly provides parts made of thermoplastic material exhibiting a high dimensional stability, namely a better resistance to creep, at high temperature. Thus, the parts can be used in a wide operating temperature range.

This is obtained by converting the PEKK so that, in the part obtained, it is predominantly (indeed even essentially or exclusively) crystallized in the form 1.

By way of example, PEKK exhibiting a content of T units of 60% (as defined below) is a particularly advantageous grade as it makes possible use by injection at approximately 320° C. However, its very slow crystallization conventionally requires regulating the temperature of the mold to approximately 80-140° C., in particular 80-120° C. (which is a lower level than the glass transition temperature, which is approximately 160° C.). This results in amorphous parts having poor properties at a temperature greater than the glass transition temperature. The invention makes it possible to strengthen the properties of the parts of this grade of PEKK at high temperature and in particular between 160° C. and 300° C. approximately.

### DESCRIPTION OF EMBODIMENTS OF THE INVENTION

The invention is now described in more detail and in a nonlimiting manner in the description which follows.

PEKK is a polymer comprising a sequence of repeat units of following formula I and/or of following formula II:

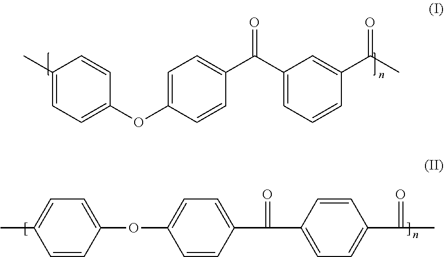

In these formulae, n is an integer.

The units of formula I are units derived from isophthalic acid (or I units), whereas the units of formula II are units derived from terephthalic acid (or T units).

In the PEKK used in the invention, the proportion by weight of T units, with respect to the sum of the T and I units, can vary from 0% to 5%; or from 5% to 10%; or from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to 100%.

Ranges from 35% to 100%, in particular from 55% to 85% and more specifically still from 60% to 80% are particularly suitable. In all the ranges set out in the present patent application, the limits are included, unless otherwise mentioned.

The choice of the proportion by weight of T units, with respect to the sum of the T and I units, is one of the factors which makes it possible to adjust the melting temperature of PEKK. A given proportion by weight of T units, with respect to the sum of the T and I units, can be obtained by adjusting the respective concentrations of the reactants during the polymerization, in a way known per se.

In the solid state, PEKK can exist in the amorphous form or in a partially crystalline form. The crystalline fraction can in particular be in the form 1 or in the form 2. The proportion by weight of PEKK in the crystalline form, and more precisely in the form 1 and/or in the form 2, can be determined by an X-ray diffractometry analysis.

By way of example, the analysis can be carried out by wide-angle X-ray scattering (WAXS), on a device of Nano-inXider® type, with the following conditions:
Wavelength: main Kα1 line of copper (1.54 angstroms).
Power of the generator: 50 kV-0.6 mA.
Mode of observation: transmission
Counting time: 10 minutes.

A spectrum of the scattered intensity as a function of the diffraction angle is thus obtained. This spectrum makes it possible to identify the presence of crystals, when peaks are visible on the spectrum in addition to the amorphous halo.

This spectrum also makes it possible to identify the presence of the form 1 and/or of the form 2 in the crystal by identifying, in the spectrum, a set of peaks characteristic of one or other form.

The main peaks characteristic of the form 1 are located at the following angular positions (2θ): 18.6°-20.6°-23.1°-28.9°.

The main peaks characteristic of the form 2 are located at the following angular positions (2θ): 15.5°-17.7°-22.6°-28.0°.

In the spectrum, the area of the above main peaks characteristic of the form 1 (denoted A1), the area of the above main peaks characteristic of the form 2 (denoted A2) and the area of the amorphous halo (denoted AH) can be measured.

The proportion (by weight) of crystalline PEKK in the PEKK is estimated by the ratio (A1+A2)/(A1+A2+AH).

The proportion (by weight) of the crystals of form 1 in the crystalline phase of the PEKK is estimated by the ratio (A1)/(A1+A2).

The proportion (by weight) of the crystals of form 2 in the crystalline phase of the PEKK is estimated by the ratio (A2)/(A1+A2).

In the PEKK used in the invention, the proportion by weight of crystalline PEKK can in particular vary from 1% to 5%; or from 5% to 10%; or from 10% to 15%; or from 15% to 20%; or from 20% to 25%; or from 25% to 30%; or from 30% to 35%; or from 35% to 40%; or from 40% to 45%; or from 45% to 50%.

For example, the PEKK is preferably crystalline in a proportion of less than 40%, more preferably of less than 30%.

It is advantageous for the content of crystalline PEKK to be relatively high, for example greater than or equal to 5%, or greater than or equal to 10%, or even greater than or equal to 15%, in order to have available parts having high mechanical performance qualities.

In the PEKK used in the invention, the proportion by weight of PEKK of form 1, with respect to the total of the crystalline PEKK, can in particular vary from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to 100%. For example, this proportion by weight of the form 1 can preferably be at least 80%, more preferably at least 90%. The crystalline PEKK can in particular be essentially composed (indeed even consist) of PEKK of form 1.

The PEKK of the parts of the invention advantageously exhibits an inherent viscosity of 0.4 to 1.5 dl/g, preferably of 0.6 to 1.12 dl/g, in 96% sulfuric acid, at the concentration of 0.005 g/ml.

The parts according to the invention can be essentially composed, indeed even consist, of PEKK.

Alternatively, they can comprise PEKK as described above and other components, such as, in particular, fillers (including fibers) and/or functional additives. Among the functional additives, it is possible in particular to include one or more surfactants, UV stabilizers, heat stabilizers and/or biocidal agents.

The PEKK can also be combined with one or more other polymers, in particular thermoplastics, belonging or not belonging to the family of the PAEKs (polyaryletherketones). Such PAEKs can in particular include polyetherketones (PEKs), polyetheretherketones (PEEKs), polyetheretherketoneketones (PEEKKs), polyetherketoneetherketoneketones (PEKEKKs), polyetheretherketoneetherketones (PEEKEKs), polyetheretheretherketones (PEEEKs), polyetherdiphenyletherketones (PEDEKs), their mixtures and their copolymers with one another or with other members of the family of the PAEKs.

Preferably, the PEKK represents, by weight, at least 50%, more preferably at least 70%, or at least 80%, or at least 90%, of all the polymers present.

In specific embodiments, only PEKK is present as polymer (with the exception of possible fillers or functional additives).

The parts according to the invention can be composite parts which comprise fillers, and in particular reinforcing fibers. The composite parts can comprise, by weight, from 1% to 99%, preferably from 30% to 90%, especially from 50% to 80% and more especially from 60% to 70% of fillers, in particular of reinforcing fibers.

The nonfibrous fillers can in particular be inorganic fillers, such as alumina, silica, calcium carbonate, titanium dioxide, glass beads, carbon black, graphite, graphene and carbon nanotubes.

The fibrous fillers can be “short” fibers or reinforcing fibers (long or continuous fibers).

The fibrous fillers can in particular be glass fibers, quartz fibers, carbon fibers, graphite fibers, silica fibers, metal fibers, such as steel fibers, aluminum fibers or boron fibers, ceramic fibers, such as silicon carbide or boron carbide fibers, synthetic organic fibers, such as aramid fibers or poly(p-phenylene benzobisoxazole) fibers, or also PAEK fibers, or also mixtures of such fibers.

Preferably, they are carbon fibers or glass fibers, and more particularly carbon fibers.

The fibers are preferably nonsized. If they are sized, they are preferably sized by a thermally stable size (that is to say, a size which does not generate, when it is subjected to temperatures exceeding 300° C., especially exceeding 350° C. and especially a temperature of 375° C., for at least 20 min, reactive entities capable of significantly reacting with PEKK).

Preferably, the reinforcing fibers are provided in the form of unidirectional fibers, for example in the form of threads bringing together several thousand individual filaments (typically from 3000 to 48 000) measuring, for example, from 6 to 10 μm in diameter for carbon fibers. Fibers of this type are known under the name of roving.

Nevertheless, the reinforcing fibers can also be arranged in a different way, for example in the mat form, or else in the form of textiles obtained by weaving of rovings.

The parts according to the invention can be manufactured according to a process comprising at least the provision of PEKK and the shaping of PEKK.

The shaping of the PEKK can be carried out according to any conventional method of shaping thermoplastics; it thus involves a phase of melting the polymer.

The shaping can in particular be carried out by extrusion, or by injection molding, or by injection/compression molding, or by coating, optionally supplemented by thermoforming or machining.

The PEKK is initially provided preferably in the form of a powder, of granules or of flakes, and/or in the form of a dispersion, in particular an aqueous dispersion.

The additives, fillers and other optional constituents of the parts can be mixed with the PEKK when the latter is in the molten state, for example by compounding in an extruder. Alternatively, the PEKK can be mixed with additives, fillers and other optional constituents in the solid state, for example in the form of a powder.

When a part comprises reinforcing fibers, it can be produced, for example, by introduction and circulation of the reinforcing fibers in a bath of aqueous dispersion of PEKK (and additives or other optional constituents). The fibers impregnated with PEKK can subsequently be removed from the bath and freed from the water, for example by drying in an infrared oven. The dried impregnated fibers can subsequently be heated until the PEKK has melted, in order to make possible the coating of the fibers by the PEKK. Alternatively, the continuous fibers can also be coated by circulating them in a fluidized bed of PEKK powder and by then heating the whole until the PEKK has melted. The coated fibers obtained are subsequently, if appropriate, shaped and proportioned, for example by calendering. It is thus possible to obtain unidirectional sheets of impregnated rovings, impregnated woven fabrics, or even fiber/matrix mixtures.

Alternatively, the objects obtained as described in the preceding paragraph are used as semi-finished products, from which a part according to the invention proper is in its turn prepared. This preparation can be carried out by first manufacturing a preform, in particular by placing or draping the semi-finished products in a mold. The composite part can be obtained by consolidation, during which stage the preform is heated, generally under pressure in an autoclave, so as to assemble the semi-finished products by melting. The semi-finished products can subsequently be assembled, for example by manual or automated drape forming or by automated fiber placement, and shaped by consolidation, in order to obtain the parts of the invention. It is also possible to coconsolidate portions of composite parts in an autoclave by means of a new thermal cycle, or to weld portions of composite parts to one another by local heating.

The content of crystalline PEKK in the part as well as the proportion of form 1 in the crystalline PEKK can be adjusted in particular according to the temperature conditions applied during the manufacturing process. For example, in the case of injection molding, regulating the temperature of the mold is a factor which makes it possible to adjust the above parameters.

In some cases, a heat treatment or annealing subsequent to the shaping proper can be applied. Such a subsequent heat treatment must in particular be used when, after shaping, the PEKK is in the exclusively amorphous form, or in a crystalline form comprising a high content of form 2.

In other cases, no heat treatment or annealing is applied. This makes it possible to avoid risks of possible deformation during such a stage. The choice of parameters suitable for the shaping (temperature of the mold in the case of molding for example, cooling gradient, and the like) can be adapted in order to make it possible to avoid such a heat treatment or annealing.

Generally, the application of a relatively high temperature during the process (for example the temperature of the mold, in the case of injection molding) is favorable to the presence of crystalline PEKK of form 1 in the final part, this being the case whatever the nature of the crystalline forms in the PEKK before shaping.

The threshold of the temperature to be applied during the process in order to obtain the desired content of crystalline PEKK of form 1 depends in particular on the nature of the PEKK and more particularly on the proportion of T units, with respect to the sum of the T and I units. For example, in the case of injection molding, for a fixed mold temperature (typically greater than 200° C. for crystalline PEKKs), form 1 will exist in a greater proportion if the content of T units is high.

By way of indication, the approximate melting points of crystalline PEKK of form 1 and of crystalline PEKK of form 2, as a function of the content of T units, appear in the following table:

| T/(T + I) Ratio | M.p. Form 2 | M.p. Form 1 |
|---|---|---|
| 60% | 270° C. | 300° C. |
| 70% | 315° C. | 332° C. |
| 80% | 355° C. | 365° C. |

These values were obtained by differential scanning calorimetry (DSC) measurements on samples predominantly of form 1 and predominantly of form 2.

Furthermore, the rate of cooling of the part after shaping or after possible annealing can optionally be adjusted in order to promote the appearance of crystals of form 1. This is because a slow cooling (for example at a rate of less than or equal to 50° C./h, or less than or equal to 30° C./h, or less than or equal to 10° C./h) is favorable to the appearance of crystals of form 1.

The parts according to the invention can be parts of any industrial or consumer object. In particular, they can be parts of medical devices.

In preferred embodiments, they are parts subjected to a relatively high temperature during their use. In particular, they can be parts of air or space locomotion craft, or parts of a drilling installation (for hydrocarbon fields), or any part located in contact with or close to an engine (for example a maritime, land or air vehicle engine) or a reactor, and in particular seals, connectors, sheaths and structural parts. They can also be parts intended to be subjected to friction, that is to say parts in movable contact with one or more surfaces, in use. Such parts can in particular be supports, rings, valve seats, gears, pistons, piston rings, valve guides, compressor blades, seals and components of engines.

In specific embodiments, the parts according to the invention are subjected, in use, to a continuous operating temperature of greater than or equal to 200° C., or greater than or equal to 230° C., or greater than or equal to 260° C., or greater than or equal to 280° C.

The continuous operating temperature is the maximum temperature at which the part retains 50% of its initial properties after 100 000 hours. It can be determined according to the standard UL 746 B.

In specific embodiments, the parts according to the invention are subjected, in use, to a maximum temperature of greater than or equal to 200° C., or greater than or equal to 250° C., or greater than or equal to 300° C., or greater than or equal to 320° C. This maximum temperature is the highest temperature to which the part is subjected, even for a short time, during the whole of its use.

It should be noted that the acceptable thresholds for continuous operating temperature and especially for maximum temperature can depend on the melting point of the PEKK and thus in particular on the proportion of T units with respect to the combined T and I units in the PEKK.

Thus, advantageously, the maximum temperature is less than or equal to the melting point of the form 1 of the PEKK used minus 5° C., preferably less than or equal to the melting point of the form 1 of the PEKK used minus 10° C., more preferably less than or equal to the melting point of the form 1 of the PEKK used minus 20° C., more preferably less than or equal to the melting point of the form 1 of the PEKK used minus 30° C. and more preferably less than or equal to the melting point of the form 1 of the PEKK used minus 40° C.

### EXAMPLES

The following examples illustrate the invention without limiting it.

### Example 1

Dumbbells in accordance with the standard ISO 527 1BA are manufactured by injection from PEKK granules of Kepstan® 8002 reference sold by Arkema, exhibiting a relative content of T units of 80%.

Dumbbells of two types A and B are prepared with the following parameters: injection temperature of 385° C., mold temperature of 273° C. for the dumbbells A and of 265° C. for the dumbbells B.

The cycle time (time of presence in the mold) is 40 seconds. After molding, the dumbbells are ejected and left to cool to ambient temperature.

In both cases, the degree or crystallinity, determined by WAXS, is 14%.

WAXS measurements make it possible to determine that the crystals are 100% form 1 in the dumbbell A (according to the invention) and 15% form 1 and 85% form 2 in the dumbbell B (comparative).

The melting point of the dumbbell A is measured at 365° C. and the melting point of the dumbbell B is measured at 359° C., by DSC.

A dynamic mechanical analysis (DMA) measurement does not reveal a significant difference in modulus between the dumbbells A and B over the range from 50 to 350° C.

Finally, monitoring measurements of strain (creep) under stress are carried out on the two types of dumbbells, at different temperatures. To do this, a tensile test is carried out by applying a given stress, and the strain of each dumbbell is monitored at the temperature under consideration.

The results are summarized in the table below:

| | | Strain | Strain |
|---|---|---|---|
| Temperature | Stress | dumbbell A | dumbbell B |
| 320° C. | 1.1 MPa | 1.5%, stable | 1.5%, stable |
| 350° C. | 0.11 MPa | 0.8%, stable | 1.3%, stable |
| 355° C. | 0.11 MPa | 1.3%, stable | 3.5%, stable |
| 360° C. | 0.11 MPa | 3.4%, stable | >15%, no stabilization, |
| | | | then rupture |

In the table below, a sample is regarded as stable when its strain ceases to change, up to a maximum duration of 20 minutes.

It is found that the parts according to the invention (dumbbell A) are more resistant to creep at a temperature greater than 320° C. than the comparative parts (dumbbell B).

### Example 2

Dumbbells in accordance with the standard ISO 527 1BA are manufactured by injection from PEKK granules of Kepstan® 6002 reference sold by Arkema, exhibiting a relative content of T units of 60%.

Dumbbells of two types A and B are prepared as follows: injection temperature of 340° C., mold temperature of 80° C., for both types of dumbbells.

After injection, the dumbbells are in the amorphous form. They are subsequently subjected to a heat treatment:
280° C. for 2 hours for dumbbell A
225° C. for 2 hours for dumbbell B.

In both cases, the degree of crystallinity, determined by WAXS, is 13%.

WAXS measurements make it possible to determine that the crystals are 95% form 1 and 5% form 2 in the dumbbell A (according to the invention) and 15% form 1 and 85% form 2 in the dumbbell B (comparative).

Monitoring measurements of strain (creep) under stress are carried out on the two types of dumbbells, at different temperatures, in the same way as in the preceding example.

The results are summarized in the table below:

| | | Strain | Strain |
|---|---|---|---|
| Temperature | Stress | dumbbell A | dumbbell B |
| 240° C. | 1.1 MPa | 2%, stable | 2%, stable |
| 285° C. | 0.11 MPa | 1%, stable | 3%, stable |
| 290° C. | 0.11 MPa | 1%, stable | 13% after 5 min, then |
| | | | rupture after 6 min |
| 300° C. | 0.11 MPa | 7% after 5 min, | Immediate rupture |
| | | then rupture after | |
| | | more than 15 min | |

In the table below, a sample is regarded as stable when its strain ceases to change, up to a maximum duration of 20 minutes.

It is found that the parts according to the invention (dumbbell A) are more resistant to creep at a temperature greater than or equal to 285° C. than the comparative parts (dumbbell B).

1. A part comprising polyetherketoneketone, in which the polyetherketoneketone is at least partially crystalline and in which at least 50% by weight of the crystalline polyetherketoneketone is of form 1, as determined according a protocol including analysis carried out by wide-angle X-ray scattering (WAXS) such that a spectrum of scattered intensity as a function of diffraction angle is obtained, wherein main peaks characteristic of form 1 are located at the following angular positions (2θ): 18.6°-20.6°-23.1°-28.9°.

2. The part as claimed in claim 1, in which at least 80% by weight of the crystalline polyetherketoneketone is of form 1.

3. The part as claimed in claim 1, in which the polyetherketoneketone comprises at least 10% by weight of crystalline polyetherketoneketone.

4. The part as claimed in claim 1, in which the polyetherketoneketone comprises terephthalic units and optionally isophthalic units, the proportion by weight of the terephthalic units, with respect to the sum of the terephthalic units and of the isophthalic units, being from 35% to 100%.

5. The part as claimed in claim 1, in which the polyetherketoneketone represents at least 30% by weight of the part.

6. The part as claimed in claim 1, which also comprises one or more additional elements chosen from fillers, one or more other polyaryletherketones, additives and the combinations of these.

7. The part as claimed in claim 1, which is a part of an air or space locomotion craft, or a part of a drilling installation, or a part intended to be positioned in contact with or close to a vehicle engine or a reactor, or a part intended to be subjected to friction.

8. The use of the part as claimed in claim 1 in an appliance, craft or system, the part being subjected to a continuous operating temperature of greater than or equal to 200° C.

9. The use of the part as claimed in claim 1 in an appliance, craft or system, the part being subjected to a maximum temperature of greater than or equal to 200° C.

10. A process for the manufacture of a part as claimed in claim 1, comprising:
the provision of polyetherketoneketone;
the shaping of the polyetherketoneketone and the at least partial crystallization of the polyetherketoneketone in the form 1.

11. The process as claimed in claim 10, in which the shaping is carried out by injection molding, by injection/compression molding or by extrusion.

12. The process as claimed in claim 10, comprising a stage of heat treatment after the shaping stage.
